(19) United States
(12) Patent Application Publication
(10) Pub. No.: US 2026/0320585 A1
(43) Pub. Date: Oct. 15, 2026

(54) SMART CONTRACT NETWORK FOR NON-CUSTODIAL ASSET RECOVERY IN CRYPTOCURRENCY NETWORKS

(71) Applicant: Circle Internet Group, Inc., New York, NY (US)

(72) Inventors: Alex Kroeger, New York, NY (US); Kaili Wang, New York, NY (US)

(21) Appl. No.: 19/648,784

(22) Filed: Apr. 15, 2026

Related U.S. Application Data
(60) Provisional application No. 63/789,191, filed on Apr. 15, 2025.

(51) Int. Cl. G06Q 20/36; G06Q 20/38

(52) U.S. Cl. CPC G06Q 20/3672; G06Q 20/3829

(57) ABSTRACT

Implementations of the present disclosure are directed to receiving, by a disperser contract executed within a cryptocurrency network, a first number of tokens of a digital asset associated with a payer, providing, by a recoverable wrapper contract executed within the cryptocurrency network, a recoverable wrapped token for each token of the first number of tokens to provide a first number of recoverable wrapped tokens, transferring, by a disperser contract executed within the cryptocurrency network, the first number of recoverable wrapped tokens to a recipient account associated with a recipient within the cryptocurrency network, and prior to expiration of a recovery period: executing a freeze function to freeze at least a portion of the first number of recoverable wrapped tokens, and executing a recovery function to transfer the at least a portion of the first number of recoverable wrapped tokens to an account associated with the payer.

### CROSS-REFERENCE TO RELATED APPLICATIONS

This application claims priority to and the benefit of U.S. Prov. App. No. 63/789,191, filed on April 15, 2025, which is expressly incorporated herein by reference for all purposes.

### TECHNICAL FIELD

This specification relates generally to digital assets and more particularly to a smart contract network to facilitate non-custodial transactions in cryptocurrency networks.

### BACKGROUND

The development of distributed ledger technology has enabled a multitude of digital transactions not available in the pre-digital, pre-Internet world. For example, distributed ledger technology enables users to hold digital assets as stores of value and mediums of exchange with immutability and traceability. In general, a digital asset can be described as a virtual store of value that leverages a distributed ledger to store, record, and validate transactions. An example digital asset includes cryptocurrencies. Distributed ledgers can be referred to as blockchains or chains.

### SUMMARY

This specification describes systems, methods, devices, and other techniques relating to transactions of digital assets in cryptocurrency networks. More particularly, implementations of the present disclosure are directed to a smart contract network that facilitates non-custodial transactions in cryptocurrency networks.

In general, innovative aspects of the subject matter described in this specification can include actions of receiving, by a disperser contract executed within a cryptocurrency network, a first number of tokens of a digital asset associated with a payer, providing, by a recoverable wrapper contract executed within the cryptocurrency network, a recoverable wrapped token for each token of the first number of tokens to provide a first number of recoverable wrapped tokens, transferring, by a disperser contract executed within the cryptocurrency network, the first number of recoverable wrapped tokens to a recipient account associated with a recipient within the cryptocurrency network, and prior to expiration of a recovery period: executing a freeze function to freeze at least a portion of the first number of recoverable wrapped tokens, and executing a recovery function to transfer the at least a portion of the first number of recoverable wrapped tokens to an account associated with the payer. Other implementations of this aspect include corresponding systems, apparatus, and computer programs, configured to perform the actions of the methods, encoded on computer storage devices.

These and other implementations can each optionally include one or more of the following features: the freeze function is initiated by the recipient and is signed by the recipient using a private key associated with the recipient within the cryptocurrency network; the recovery function is initiated by an arbiter and is signed by the arbiter using a private key associated with the arbiter within the cryptocurrency network; the recovery function is executed by a returner contract executed within the cryptocurrency network; actions further include determining that a disperse condition has occurred, wherein providing the first number of recoverable wrapped tokens and transferring the first number of recoverable wrapped tokens are performed in response to the disperse condition; the disperse condition includes one of a number of minutes since a last dispersal meets a threshold number of minutes, and a number of recipient that have received payments since a last dispersal meets a threshold number of recipients; actions further include receiving, by the disperser contract, a second number of tokens of a digital asset associated with a second payer, providing, by the recoverable wrapper contract, a recoverable wrapped token for each token of the second number of tokens to provide a second number of recoverable wrapped tokens, transferring, by the disperser contract, the second number of recoverable wrapped tokens to a recipient account associated with the recipient within the cryptocurrency network, transferring at least a portion of the second number of recoverable wrapped tokens to a recovery pool, and transferring a number of tokens from the recovery pool to the recipient account, the number of tokens being equal in value to the at least a portion of the second number of recoverable wrapped tokens; and transferring at least a portion of the second number of recoverable wrapped tokens to a recovery pool and transferring a number of tokens from the recovery pool to the recipient account are executed prior to expiration of a recovery period defined by the recovery wrapper contract.

The present disclosure also provides a non-transitory computer-readable storage medium coupled to one or more processors and having instructions stored thereon which, when executed by the one or more processors, cause the one or more processors to perform operations in accordance with implementations provided herein.

It is appreciated that the methods and systems in accordance with the present disclosure can include any combination of the aspects and features described herein. That is, methods and systems in accordance with the present disclosure are not limited to the combinations of aspects and features specifically described herein, but also include any combination of the aspects and features provided.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is an example architecture in accordance with implementations of the present disclosure.

FIG. 2 depicts a conceptual architecture in accordance with implementations of the present disclosure.

FIG. 3 is a flowchart of an example process that can be executed in accordance with implementations of the present disclosure.

Like reference numbers and designations in the various drawings indicate like elements.

### DETAILED DESCRIPTION

The technology of this patent application is directed to transactions of digital assets in cryptocurrency networks. More particularly, implementations of the present disclosure are directed to a smart contract network that facilitates non-custodial transactions in cryptocurrency networks.

In some implementations, actions include receiving, by a disperser contract executed within a cryptocurrency network, a first number of tokens of a digital asset associated with a payer, providing, by a recoverable wrapper contract executed within the cryptocurrency network, a recoverable wrapped token for each token of the first number of tokens to provide a first number of recoverable wrapped tokens, transferring, by a disperser contract executed within the cryptocurrency network, the first number of recoverable wrapped tokens to a recipient account associated with a recipient within the cryptocurrency network, and prior to expiration of a recovery period: executing a freeze function to freeze at least a portion of the first number of recoverable wrapped tokens, and executing a recovery function to transfer the at least a portion of the first number of recoverable wrapped tokens to an account associated with the payer.

To provide context for the subject matter of the present disclosure, and as introduced above, users can hold digital assets as stores of value and mediums of exchange. In general, a digital asset can be described as a virtual store of value that leverages a peer-to-peer network to store, record, and validate transactions. The peer-to-peer network can maintain a distributed ledger (e.g., blockchain), which can be described as a decentralized database that immutably stores transactions across the peer-to-peer network. Example digital assets can include, without limitation, cryptocurrencies (e.g., stablecoins), non-fungible tokens (NFTs), security tokens, tokenized money market funds (T-MMF), and the like (e.g., tokenized government obligations).

In some examples, a cryptocurrency can be described as a digital currency that uses cryptography to secure transactions that are recorded in a distributed ledger (e.g., blockchain). In some examples, a stablecoin can be described as a cryptocurrency having a value that is tied (pegged) to the value of a real-world, non-digital asset, such as a fiat currency, a commodity, or a financial instrument. Stablecoins are absent the volatility of other cryptocurrencies and, as such, are a useful medium of exchange. An example stablecoin includes, without limitation, USDC™.

Implementations of the present disclosure are described in further detail herein with reference to example peer-to-peer networks (also referred to herein as chain networks), each maintaining a respective chain. Some example peer-to-peer networks can each be described as an Ethereum-compatible network. Ethereum can be described as a decentralized computing infrastructure that executes a virtual machine, referred to as the Ethereum virtual machine (EVM), to execute transactions on a chain. The EVM can be described as a global singleton and operates as a single-instance computer, globally across nodes of the peer-to-peer network. That is, each node in the network executes a local copy of the EVM to execute transactions on the chain. The chain of the peer-to-peer network records the changing state of the EVM as transactions are processed. While Ethereum is referenced herein for purposes of illustration, it is contemplated that implementations of the present disclosure can be realized using any appropriate peer-to-peer network (e.g., networks that provide on-chain computing; EVM-compatible chains). Example peer-to-peer networks can include, without limitation, Arbitrum, Avalanche, and Base, among several others, each of which is EVM-compatible. It is contemplated, however, that implementations of the present disclosure can be realized on non-EVM peer-to-peer networks, such as Solana, Aptos, Sui, and the like.

Digital assets can be used to as payments for products and/or services. In some examples, digital payment technologies enable merchants to accept payments from users in digital assets. To facilitate payments using digital assets of cryptocurrency networks, payments are held on-chain. In general, on-chain refers to transactions that occur on a blockchain and have been verified and authenticated, such that the data stored on the blockchain is immutable and permanent within the cryptocurrency network. However, in order for payments to be held on-chain on an institutional and large scale, refunds and chargebacks must be supported. It might be assumed that, if the cryptocurrency network is permissioned (i.e., closed and not publicly accessible; can have an access control layer, such that only permissioned users are allowed to access), then it can be relied that the recipient (e.g., merchant) can simply send back the funds. However, such an assumption would be naive given the complexities and, for example, regulatory framework around payments.

By way of non-limiting example, a user can purchase a “new” product online, but receive a product that has clearly been used. In traditional payment systems, such as credit cards, the issuer of the credit card can provide a process for dispute resolution to enable the user to dispute the charge. Such a trusted dispute resolution process enables buyers (payers) and sellers (recipients) to confidently engage in commerce. However, in using digital assets, such as cryptocurrencies (e.g., stablecoins), to transact in commerce, effective refund or chargeback mechanisms are absent. As such, transactions that use digital assets are more akin to cash transactions, where the payment involves only the movement of value from one party to another (from payer to recipient).

Without an on-chain arbiter protocol, a customer (payer) can buy from a merchant (recipient), for example, and the merchant can immediately receive the funds and use the funds however they wish. If they wish to refund the customer, but the merchant has already off-ramped (i.e., converted the digital assets to fiat currency), the merchant either needs to do the refund over fiat rails (expensive and slow), or needs to on-ramp again (i.e., convert fiat currency to digital assets), which introduces additional complexities and consumption of technical resources (e.g., computing that is executed to on-ramp fiat to digital currency). If the recipient had not yet off-ramped, there needs to be some additional infrastructure within the cryptocurrency network to return funds to the payer’s original off-chain payment method. In chargebacks especially (but also refunds), there are scenarios where the return of funds to the payer must still take place, but it cannot be assumed that the recipient will initiate and source those funds.

One approach to addressing this issue is to delegate the task of dispute resolution to an all-powerful arbiter that would, for example, escrow funds for a period of time before sending payment to the recipient (or returning to the purchaser). In the context of cryptocurrency networks, this escrow account could be a single address controlled by the arbiter, who performs accounting and dispute resolution off-chain. While this solution is tempting in its simplicity, it introduces an entity that must be trusted by all parties. In short, such an architecture is not trustless. Another problem with an all-powerful arbiter is that they have the ability to take (or lose) the digital assets held in the escrow account. As such, the all-powerful arbiter is custodial, meaning that they have full control and possession of the digital assets until they choose to forward the digital assets to the recipient (or return to the payer).

In view of the foregoing, implementations of the present disclosure are directed to a smart contract network that facilitates non-custodial dispute resolution in cryptocurrency networks. More particularly, implementations of the present disclosure provide a smart contract network that can include a disperser contract, a returner contract, and a recoverable wrapper contract. In some examples, the disperser contract receives a number of tokens from a payer for a transaction with a recipient, interacts with the recoverable wrapper contract to provide recoverable wrapped tokens that are transferred to a recipient account of the recipient. During a recovery period defined by the recoverable wrapper contract, the recoverable wrapped tokens are unsettled and cannot be unwrapped. In response to a refund, the recipient can freeze the recoverable wrapped tokens and the returner contract can return unwrapped tokens to the payer. After the recovery period, the recoverable wrapped tokens are settled and can be unwrapped. In some examples, the smart contract network includes a recovery pool (R-pool) contract to facilitate early withdrawals, prior to expiration of the recovery period, as described in detail herein.

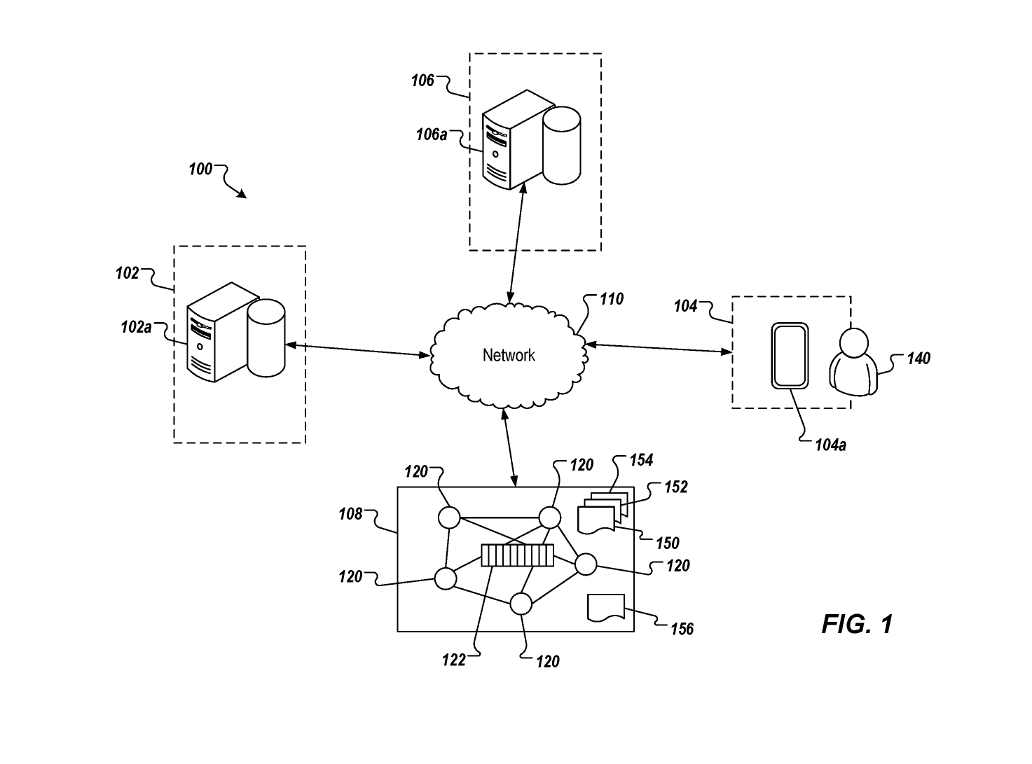

FIG. 1 depicts an example environment 100 that can be used to execute implementations of the present disclosure. In some examples, the example environment 100 enables entities to participate in a cryptographic network for secure communications. The example environment 100 includes an arbiter system 102, a payer system 104, a recipient system 106, a cryptographic network 108, and a network 110. In some examples, the network 110 includes a local area network (LAN), wide area network (WAN), the Internet, or a combination thereof, and connects web sites, user devices (e.g., computing devices), and back-end systems. In some examples, the network 110 can be accessed over a wired and/or a wireless communications link.

In the example use case, the cryptographic network 108 can be provided as a cryptocurrency network that enables a provider of a cryptocurrency (referred to herein as a minting entity) to distribute tokens of a cryptocurrency to users and that enables users to execute transactions related to the cryptocurrency. The cryptographic network 108 can be described as a peer-to-peer network of nodes 120 and transactions related to the cryptocurrency are immutably stored within a blockchain 122. For example, the blockchain 122 is a distributed ledger that is updated and stored across multiple nodes within the cryptographic network 108. Although the cryptographic network 108 is depicted separately from the network 110, it is contemplated that at least a portion of the cryptographic network 108 can be provided within the network 110 (e.g., as nodes that are distributed across the Internet).

In the depicted example, the arbiter system 102 includes a computing device 102a, which can, for example, represent one or more servers. In some examples, the arbiter system 102 can be operated by or on behalf of a third-party that acts as an arbiter in accordance with implementations of the present disclosure. In some examples, the third-party is a provider entity that generates and distributes a cryptocurrency. In this example, the computing device 102a is operated by the provider entity to mint tokens of the cryptocurrency and distribute tokens to users, as well as execute transactions. In some examples, the third-party can be any appropriate entity (e.g., the provider entity, an artificial intelligence (AI) agent, a multi-party computation (MPC) group (i.e., multiple parties functioning as the arbiter through cryptographic transactions)) that can function as a trust-minimized, non-custodial arbiter, as described in further detail herein. Transactions associated with the cryptocurrency are recorded in the blockchain 122 of the cryptographic network 108. In some examples, the computing device 102a can function as a node of the cryptographic network 108.

In the depicted example, the payer system 104 includes a computing device 104a. In some examples, the computing device 104a can include, without limitation, a server, a desktop computer, a laptop computer, a tablet computing device, and a smartphone. In some implementations, a user 140 uses the device 104a to execute transactions within the network 110 and/or the cryptographic network 108. In some examples, transactions executed in the cryptographic network 108 are immutably recorded in the blockchain 120 of the cryptographic network 108. Example transactions can include, without limitation, purchasing tokens of a cryptocurrency from the provider entity, transferring tokens of cryptocurrency to recipients, and transferring tokens of cryptocurrency to arbiter(s).

In the depicted example, the recipient system 106 includes a computing device 106a. In some examples, the computing device 106a can include, without limitation, a server, a desktop computer, a laptop computer, a tablet computing device, and a smartphone. In some implementations, a commercial entity uses the device 106a to execute transactions within the network 110 and/or the cryptographic network 108. In some examples, transactions executed in the cryptographic network 108 are immutably recorded in the blockchain 122 of the cryptographic network 108. Example transactions can include, without limitation, receiving tokens of a cryptocurrency.

In accordance with implementations of the present disclosure, a smart contract network is provisioned within the cryptocurrency network 108 that enables arbitration between the user 140 and the commercial entity. In some examples, the smart contract network includes a disperser contract 150, a returner contract 152, and a recoverable wrapper contract 154. In some examples, the disperser contract 150 and the returner contract 152 are deployed to the cryptocurrency network 108 by an arbiter, such as the third-party of the arbiter system 102. In some examples, the recoverable wrapper contract 154 is deployed to the cryptocurrency network 108 by a provider of a cryptocurrency (e.g., an entity that mints the cryptocurrency). In some examples, the smart contract network includes a recovery pool (R-pool) contract 156 to facilitate early withdrawals, as described in further detail herein.

In some examples, the user 140 can interact with an entity over the network 110, which interactions can result in the user 140 transferring tokens of cryptocurrency to the entity. For example, the user 140 can purchase goods and/or services from the entity. In consideration for the goods and/or services, the user 140 initiates a transfer of tokens of the cryptocurrency intended for the entity. As described in further detail herein, recoverable wrapped tokens are transferred to the entity (e.g., an account of the entity within the cryptocurrency network 108) for an intermediate period of time. In some examples, the recoverable wrapped tokens are ultimately unwrapped and tokens are provided to the entity or are returned to the user 140 by the smart contract network.

As described in further detail herein, implementations of the present disclosure use recoverable wrappers and recovery pools (R-pools) to enable transactions in cryptocurrency networks, such as transactions described herein.

At a high-level, a recoverable wrapper can be described as a smart-contract layer around a token of a cryptocurrency (e.g., an ERC-20 token). A token is deposited into the a recoverable wrapper contract (e.g., the recoverable wrapper contract 154 of FIG. 1) and is locked there. The recoverable wrapper contract mints an equal amount of wrapped tokens associated with a wrapper. The wrapper adds limited recovery features without changing the underlying token itself. After a transfer, the wrapped tokens remain recoverable for a configurable window (e.g., 24 hours, 1 week, 2 weeks). A feature of recoverable wrappers is a split between settled balances and unsettled balances. Here, recently recoverable wrapped tokens are initially unsettled and can still be clawed back during the recovery window. Once the recovery window expires, the recoverable wrapped tokens become settled and are no longer recoverable. Only settled recoverable wrapped tokens can be unwrapped back into the underlying token (the base ERC-20 token). The recoverable wrapper is configurable (e.g., vary the recovery-window length, enable unsettled tokens to be transferable, choose a recovery/arbitration model). Further detail of recoverable wrappers is provided in Recoverable Wrapper Tokens, Wang et al., November 2023, which is expressly incorporated herein by reference in the entirety for all purposes.

As described in further detail, recoverable wrapped tokens are sent to recipients (e.g., merchants) as unsettled tokens. For example, incoming recoverable wrapped tokens initially go into an unsettled balance of a recipient and remain there during the recovery window. If the payer (e.g., customer) wants a refund, the payer must act before the recovery window expires. Once the recovery window expires, the recoverable wrapped tokens move from unsettled to settled, and settled tokens cannot be clawed back by governance.

In some examples, the payer initiates a recovery request. Here, the recoverable wrapper is configured, such that a designated address (e.g., the recipient account) has authority to freeze disputed funds. For example, the payer can provide whatever evidence return rules of the recoverable wrapper require. In some examples, the recipient can first freeze the disputed funds, then initiate recovery. The freeze preserves the status quo and buys time to gather evidence and decide whether recovery is justified.

If unsettled tokens are transferable, the freeze/recovery process may trace the tokens beyond the recipient. For example, if the recipient forwarded the unsettled recoverable wrapped tokens to another party, and that other party to even another party, the recovery request can trace the recoverable wrapped tokens to the current holder. In some examples, such tracing can use an on-chain discovery process. If unsettled recoverable wrapped tokens are non-transferable, recovery is simpler. In that configuration, the recipient cannot spend or unwrap the recoverable wrapped tokens before settlement, so the disputed funds are recovered directly from the recipient rather than traced through downstream holders.

The payer cannot unilaterally claw back the recoverable wrapped tokens. If the recovery request is approved, the arbiter executes the recovery step. After adjudication, the arbiter (e.g., the returner contract) causes the recoverable wrapped tokens to be recovered from the recipient’s account (i.e., on-chain recipient account), or the current holder, if the recoverable wrapped tokens are transferable) and returns the recoverable wrapped tokens in accordance with recovery logic.

In some examples, signatures (cryptographic signatures) are used to determine authorized callers for each on-chain action. For example, in initiating a recovery, the payer can sign a transaction (or message) using a private key associated with an on-chain account of the payer. As another example, the recipient can sign a freeze transaction using a private key associated with the recipient. As another example, the arbiter can sign a recovery transaction using a private key associated with the arbiter.

As introduced above, a R-pool can be implemented to enable early withdrawal by recipients. At a high-level, a R-pool enables recoverable wrapped tokens to be accepted for transactions, even though they remain subject to post-transfer revocation during the recovery period. A R-pool can be described as a mechanism for exchanging unsettled recoverable wrapped tokens for immediate base tokens, functioning as a decentralized insurance-like protocol, because the R-pool takes on the risk that some recoverable wrapped tokens it acquires may later be clawed back, while the recipient gets immediate liquidity in ordinary base tokens instead of waiting for settlement.

For purposes of non-limiting illustration, an example of how a R-pool functions with recoverable wrappers is provided. In the example, tokens are received and are wrapped using the recoverable wrapper, as described herein, to provide recoverable wrapped tokens. A payout to a recipient can be made using the recoverable wrapped tokens. A recipient that is willing to wait can hold the recoverable wrapped tokens until they settle (i.e., the recovery period expires) and then unwrap the recoverable wrapped tokens to provide the (base) tokens. However, if the recipient wants to use the value immediately, the recipient user can trade the (unsettled) recoverable wrapped tokens into a R-pool and receive base tokens right away. In this manner, the R-pool serves as a market bridge between the security benefits of recoverable wrappers and the immediate composability expected by some recipients. Further detail on R-pools is provided in R-Pool and Settlement Markets for Recoverable ERC-20R Tokens, Wang et al., November 2023, which is expressly incorporated herein by reference in the entirety for all purposes.

Implementations of the present disclosure are described in further detail herein with reference to an example use case. The example use case includes a user, as a payer, paying in fiat currency, which is converted to cryptocurrency, and a merchant, as a recipient, ultimately receives fiat currency. It is contemplated, however, implementations of the present disclosure can be realized in any appropriate use case. For example, the payer can pay directly in cryptocurrency and the recipient can receive cryptocurrency, without involvement of fiat currency.

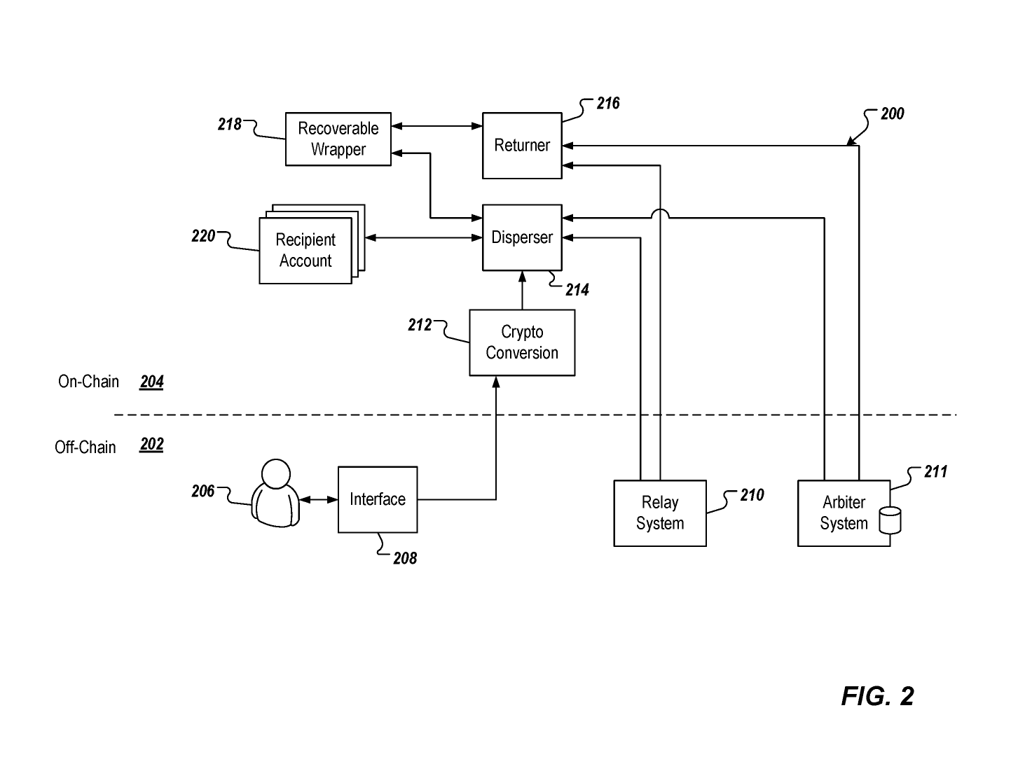

FIG. 2 depicts a conceptual architecture 200 in accordance with implementations of the present disclosure. The example of FIG. 2 depicts an off-chain side 202, an on-chain side 204, a payer 206 (e.g., a user), an interface 208, a relay system 210, an arbiter system 211, a cryptocurrency conversion system 212, a disperser contract 214, a returner contract 216, a recoverable wrapper contract 218, and one or more recipient accounts 220. In some examples, each recipient account 220 corresponds to a recipient that can receive payments from payers, such as the payer 206, that are potentially subject to return in accordance with implementations of the present disclosure. In some examples, each recipient is registered with the arbiter for use of the smart contract network in accordance with implementations of the present disclosure.

In some examples, the disperser contract 214 is deployed by the arbiter and includes a wrap disperse function (wrapDisperse(uint amount, Payout[] payouts)) that returns a boolean value. In some examples, the wrap disperse function wraps amount into recoverable form (recoverable wrapper token) as described herein, and Payout is a structure with uint amount and address to fields. In some examples, the wrap disperse function goes through the payouts array and sends payout.amount of recoverable wrapped tokens to payout.to (e.g., address of a recipient account 220).

In some examples, the returner contract 216 is deployed by the arbiter and includes a complete refund function (completeRefund(from, rawIndex, amount, payer)) that handles a single refund. In some examples, the complete refund function can only be called by the arbiter. In some examples, the complete refund function calls a token recovery function (token.recover) and sends (base) for the payer.

In some examples, the recoverable wrapper contract 218 does not allow transfers of unsettled funds, except in cases of early withdrawal, described in further detail herein. The recoverable wrapper contract 218 includes a freeze function (freeze(recordID, amount)) and a recover function (recover(Suspension[] freezed, to)).

In some implementations, and in the example use case, the payer 206 initiates a payment through the interface 208. In some examples, the interface 208 is provided by the arbiter. For example, the payer 206 can interact with a recipient system (e.g., an e-commerce website provided by the recipient) to select products and/or services and, for payment, the recipient system can navigate the payer 206 to the interface 208. In some examples, and in the example use case, the payer 206 pays in fiat (e.g., by credit card, by bank transfer) which is converted into cryptocurrency (e.g., USDC^{TM}) by the cryptocurrency conversion system 212.

In some examples, the transaction is sent to the disperser contract 214 (e.g., deployed to the cryptocurrency network by the arbiter). Payments to all recipients that are registered with the arbiter first land in the disperser contract 214. In some examples, the relayer system 210 periodically calls the wrap disperse function (wrapDisperse(uint amount, Payout[] payouts) function of the disperser contract 214. For example, the relayer system 210 runs a cron job that regularly checks the number of payments that have landed in the disperser contract 214 on behalf of recipients. For example, after either m minutes have passed since the last dispersal or at least x recipients have received payments since the last dispersal, the wrap disperse function is called, where amount is the total amount that has been received by disperser contract 214 since the last dispersal and payouts is set as, for each recipient who has received a payment since the last dispersal, calculate how much in total the recipient has received since the last dispersal, and add Payout(amount_received, recipient) to the payouts array.

In response to calling of the wrap disperse function, the disperser contract 214 interacts with the recoverable wrapper contract 218 to wrap tokens of the cryptocurrency using a recoverable wrapper to provide recoverable wrapped tokens. For example, tokens of USDC^{TM} are wrapped to provide recoverable wrapped tokens of USDC^{TM} (e.g., usdc usdcR). For each payout in payouts: transfer payout.amount in recoverable wrapped tokens to payout.to, which is the recipient account 220 of the respective recipient. In this manner, the recipient account 220 holds recoverable wrapped tokens.

In some implementations, the arbiter system 211 maintains a database that stores and keeps track of which incoming payments (e.g., indexed by unique order number) correspond to which unsettled recoverable wrapped tokens sent out to respective recipient accounts 220. In some examples, the database includes an integer field unsettledRecordID for each payment. In some examples, once landed in the recipient account 220, the recoverable wrapped tokens are not transferrable until the recovery window (e.g., 2 weeks) has expired. This is enforced by the recoverable wrapper contract 218, as described herein.

In the event of a refund, the payer or the recipient can trigger a refund process through the arbiter system 211. In response to triggering the refund, the recipient is prompted to sign (using the private key of the recipient) a freeze transaction to freeze a refund amount on the unsettled record that corresponds to the order that the payer is being refunded for. Only the owner of the recoverable wrapped tokens (i.e., the recipient) is able to call the freeze function (freeze(recordID, amount)).

Accordingly, implementations of the present disclosure provide a two-step refund process that includes freeze and recover. In this manner, non-custodiality is maximized. For example, if just recover is implemented, the arbiter would need to be able to trigger it by themselves in case of the edge case scenario of a fraudulent merchant. This would mean that the arbiter would have power over the tokens during the recovery window. Because refunds are always first initiated by the recipient, the initiation step can act as an “unlock” step in which the recipient is agreeing to allow the arbiter to simply complete the refund process for them. That is, the arbiter can execute the recovery.

Further, because the order with the recipient can involve physical products, there can be policies around requiring the payer to ship the product back to the shipping facility. This can take multiple days. If a recipient receives a refund request on day 13 of a 2 week recovery window, for example, the recipient would initiate the refund process and wait until the shipment is returned before refunding the payer. This would require the refund process to freeze, so that it is still able to be recovered back to the payer after expiration of the recovery window.

Continuing, once the refund is ready to be completed and delivered to the participant, the arbiter system 211 checks whether the returner contract 216 has sufficient tokens to cover the refund amount. If there are insufficient tokens, the arbiter system 211 funds the return contract 216 with additional tokens sufficient to over the refund amount. In some examples, the arbiter system 211 calls a complete refund function (completeRefund(from, rawIndex, amount, payer)) of the return contract 216. In some examples, the complete refund function calls the recover function (recover(Suspension[] freezed, to)), where to being the address of the returner contract 216. It can be noted that only the returner contract 216 can call the recover function. In some examples, freezed is an array of a suspension object that contains from, recordID, amount, where from is the address of the respective recipient account 220. The recover function deducts the amount from the unsettled balance of from and adds it to the unsettled balance of the returner contract 216, creating a new unsettled record in the account of the returner contract 216. After the returner contract 216 receives the recoverable wrapped tokens, the returner contract 216 transfers an equivalent amount of (base) tokens for return to the payer (e.g., to a liquidation address of the payer (payer)).

In some implementations, early withdrawal can be provided to enable recipients to have access to (base) tokens before expiration of the recovery window. For example, recipients might want to access and spend their incoming revenue earlier than the recover window (e.g., pay off suppliers or other costs). In some instances, recipients would be amendable to paying a fee in order to do so. From the perspective of the arbiter, it makes sense to charge a fee to dissuade recipients from using early withdrawal too often.

In accordance with implementations of the present disclosure, a R-pool contract (e.g., the R-pool contract 156 of FIG. 1) can be deployed, which facilitates exchanges from unsettled recoverable wrapped tokens to (base) tokens. In some examples, the R-pool contract charges a risk premium based on the possibility of recovery (refund in this case). The risk premiums are paid to one or more liquidity providers (LPs) that fund the R-pool contract with tokens.

In some examples, a recipient can trigger an early withdrawal through the arbiter system 211 and the arbiter is prompted to execute a transaction to exchange an amount of recoverable wrapped tokens with tokens in the R-pool contract. In executing the transaction, amount is transferred to the R-pool contract. The arbiter evaluates potential of refund or sets a default premium fee, and matches the order, where amount - fee of (base) tokens is sent from the arbiter to the recipient account 220 of the respective recipient and the arbiter receives amount in recoverable wrapped tokens. At this point, the recipient has amount - fee of (base) tokens in their recipient account 220 and can use as they deem fit (e.g., withdraw at any time).

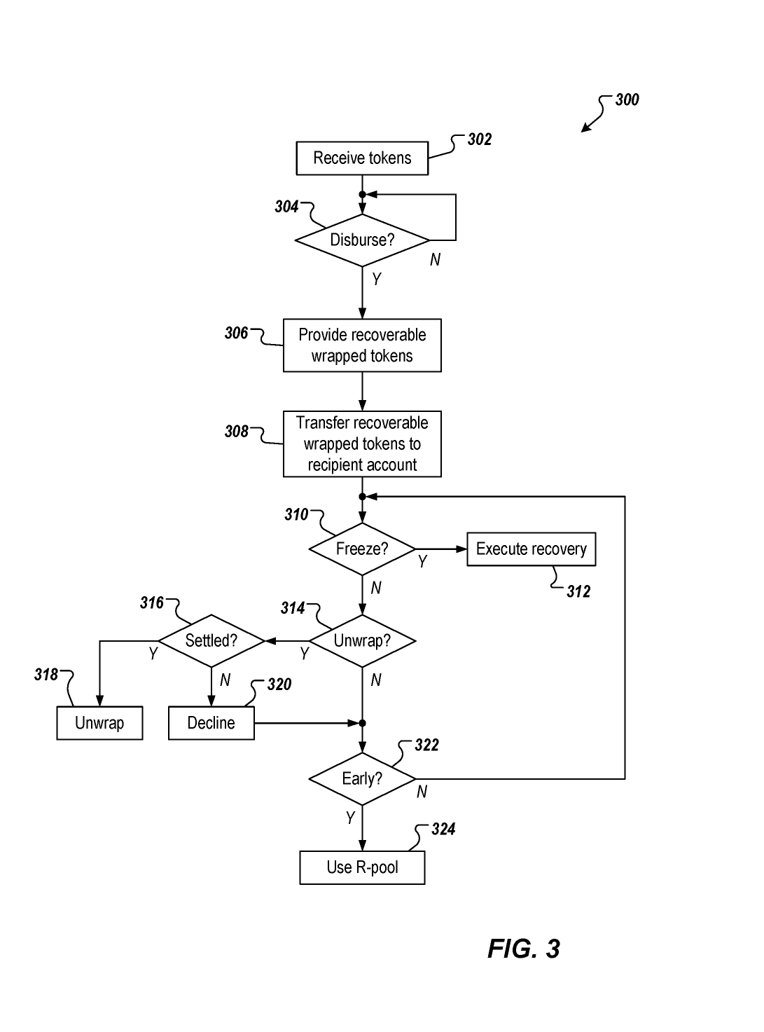

FIG. 3 is a flowchart of an example process 300 that can be executed in accordance with implementations of the present disclosure. In some examples, the example process 300 is provided using one or more computer-executable programs executed by one or more computing devices.

A number of tokens of a digital asset is received (302). For example, and as described in detail herein, a payer can interact with a recipient to execute a transaction (e.g., purchase goods/services), which results in transfer of the number of tokens of the digital asset (e.g., cryptocurrency) intended for the recipient. In some examples, a transaction can be executed that results in a disperser contract (e.g., the disperser contract 214 of FIG. 2) holding the number of tokens associated with a recipient identifier that uniquely identifies the recipient. It is determined whether a number of recoverable wrapped tokens are to be dispersed (304). For example, and as described in detail herein, recoverable wrapped tokens are periodically dispersed (e.g., the relayer system 210 periodically calls a wrap disperse function of the disperser contract 214).

If the number of recoverable wrapped tokens are not yet to be dispersed, the example process 300 loops back. If the number of recoverable wrapped tokens are to be dispersed, the number of recoverable wrapped tokens are provided (306) and the number of recoverable wrapped tokens are transferred to a recipient account (308). For example, and as described in detail herein, in response to calling of the wrap disperse function, the disperser contract interacts with a recoverable wrapper contract (e.g., the recoverable wrapper contract 218 of 218) to wrap the number of tokens using a recoverable wrapper to provide the number of recoverable wrapped tokens. The number of recoverable wrapped tokens are transferred to a recipient account (e.g., a recipient account 220 of FIG. 2) associated with the recipient.

It is determined whether the number of recoverable wrapped tokens are to be frozen (310). For example, and as described in detail herein, a refund process can be initiated. If the refund process is initiated, a freeze function (e.g., of the recoverable wrapper contract) is called (e.g., by the recipient), which freezes tolling of a recovery period associated with the recoverable wrapped tokens. If the number of recoverable wrapped tokens are to be frozen, the recoverable wrapper tokens are frozen and recovery is executed (312). For example, and as described in detail herein, a recovery function (e.g., of the recoverable wrapper contract) is called (e.g., by an arbiter) to provide unwrapped tokens that are transferred to the payer (e.g., a payer account associated with the payer).

If the number of recoverable wrapped tokens are not to be frozen, it is determined whether an unwrap transaction has been attempted (314). If an unwrap transaction has been attempted, it is determined whether the recoverable wrapped tokens have been settled (316). For example, and as described in detail herein, if the recovery period of the recoverable wrapped tokens has expired, the recoverable wrapped tokens are determined to be settled. If the recoverable wrapped tokens have been settled, the recoverable wrapped tokens are unwrapped (318). For example, an unwrap function of the recoverable wrapped contract unwraps the recoverable wrapped tokens to provide unwrapped tokens to the recipient account. If the recoverable wrapped tokens have not been settled, the unwrap transaction is declined (320) and the example process 300 continues.

It is determined whether an early withdrawal has been requested and approved (322). If an early withdrawal has not been requested or has not been approved, the example process 300 loops back. If an early withdrawal has been requested and approved, a R-pool is used to perform the early withdrawal (324). For example, and as described in detail herein, a transaction can be executed (e.g., by the arbiter) to exchange the number of recoverable wrapped tokens of the recipient with an equivalent number of tokens (minus any fees) provided in the R-pool contract.

This specification uses the term “configured” in connection with systems and computer program components. For a system of one or more computers to be configured to perform particular operations or actions means that the system has installed thereon software, firmware, hardware, or a combination thereof that, in operation, cause the system to perform the operations or actions. For one or more computer programs to be configured to perform particular operations or actions means that the one or more programs include instructions that, when executed by data processing apparatus, cause the apparatus to perform the operations or actions.

Implementations of the subject matter and the functional operations described in this specification can be realized in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs (i.e., one or more modules of computer program instructions) encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. The program instructions can be encoded on an artificially-generated propagated signal (e.g., a machine-generated electrical, optical, or electromagnetic signal) that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry (e.g., an FPGA (field programmable gate array) or an ASIC (application-specific integrated circuit)). The apparatus can optionally include, in addition to hardware, code that creates an execution environment for computer programs (e.g., code) that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data (e.g., one or more scripts stored in a markup language document) in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a data communication network.

The processes and logic flows described in this specification can be performed by one or more programmable computers executing one or more computer programs to perform functions by operating on input data and generating output. The processes and logic flows can also be performed by special purpose logic circuitry (e.g., a FPGA, an ASIC), or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random-access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data (e.g., magnetic, magneto-optical disks, or optical disks). However, a computer need not have such devices. Moreover, a computer can be embedded in another device (e.g., a mobile telephone, a personal digital assistant (PDA), a mobile audio or video player, a game console, a Global Positioning System (GPS) receiver), or a portable storage device (e.g., a universal serial bus (USB) flash drive) to name just a few.

Computer-readable media suitable for storing computer program instructions and data include all forms of non-volatile memory, media and memory devices, including by way of example semiconductor memory devices (e.g., EPROM, EEPROM, and flash memory devices), magnetic disks (e.g., internal hard disks or removable disks), magneto-optical disks, and CD-ROM and DVD-ROM disks.

To provide for interaction with a user, implementations of the subject matter described in this specification can be provisioned on a computer having a display device (e.g., a CRT (cathode ray tube) or LCD (liquid crystal display) monitor) for displaying information to the user and a keyboard and a pointing device (e.g., a mouse, a trackball), by which the user can provide input to the computer. Other kinds of devices can be used to provide for interaction with a user as well; for example, feedback provided to the user can be any form of sensory feedback (e.g., visual feedback, auditory feedback, tactile feedback); and input from the user can be received in any form, including acoustic, speech, or tactile input. In addition, a computer can interact with a user by sending documents to and receiving documents from a device that is used by the user; for example, by sending web pages to a web browser on a user’s device in response to requests received from the web browser. Also, a computer can interact with a user by sending text messages or other forms of message to a personal device (e.g., a smartphone that is running a messaging application), and receiving responsive messages from the user in return.

Implementations of the subject matter described in this specification can be realized in a computing system that includes a back-end component (e.g., as a data server) a middleware component (e.g., an application server), and/or a front-end component (e.g., a client computer having a graphical user interface, a web browser, or an app through which a user can interact with implementations of the subject matter described in this specification, or any combination of one or more such back-end, middleware, or front-end components. The components of the system can be interconnected by any form or medium of digital data communication (e.g., a communication network). Examples of communication networks include a local area network (LAN) and a wide area network (WAN) (e.g., the Internet).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a user device (e.g., for purposes of displaying data to and receiving user input from a user interacting with the device), which acts as a client. Data generated at the user device (e.g., a result of the user interaction) can be received at the server from the device.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially be claimed as such, one or more features from a claimed combination can in some cases be excised from the combination, and the claimed combination may be directed to a sub-combination or variation of a sub-combination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations are within the scope of the following claims. For example, the actions recited in the claims can be performed in a different order and still achieve desirable results. As one example, the processes depicted in the accompanying figures do not

necessarily require the particular order shown, or sequential order, to achieve desirable results. In some cases, multitasking and parallel processing may be advantageous.

What is claimed is:

1. A computer-implemented method for facilitating transactions of digital assets using a smart contract network within cryptocurrency networks, comprising:
receiving, by a disperser contract executed within a cryptocurrency network, a first number of tokens of a digital asset associated with a payer;
providing, by a recoverable wrapper contract executed within the cryptocurrency network, a recoverable wrapped token for each token of the first number of tokens to provide a first number of recoverable wrapped tokens;
transferring, by a disperser contract executed within the cryptocurrency network, the first number of recoverable wrapped tokens to a recipient account associated with a recipient within the cryptocurrency network; and
prior to expiration of a recovery period:
executing a freeze function to freeze at least a portion of the first number of recoverable wrapped tokens, and
executing a recovery function to transfer the at least a portion of the first number of recoverable wrapped tokens to an account associated with the payer.

2. The computer-implemented method of claim 1, wherein the freeze function is initiated by the recipient and is signed by the recipient using a private key associated with the recipient within the cryptocurrency network.

3. The computer-implemented method of claim 1, wherein the recovery function is initiated by an arbiter and is signed by the arbiter using a private key associated with the arbiter within the cryptocurrency network.

4. The computer-implemented method of claim 1, wherein the recovery function is executed by a returner contract executed within the cryptocurrency network.

5. The computer-implemented method of claim 1, further comprising determining that a disperse condition has occurred, wherein providing the first number of recoverable wrapped tokens and transferring the first number of recoverable wrapped tokens are performed in response to the disperse condition.

6. The computer-implemented method of claim 5, wherein the disperse condition comprises one of:
a number of minutes since a last dispersal meets a threshold number of minutes; and
a number of recipient that have received payments since a last dispersal meets a threshold number of recipients.

7. The computer-implemented method of claim 1, further comprising:
receiving, by the disperser contract, a second number of tokens of a digital asset associated with a second payer;
providing, by the recoverable wrapper contract, a recoverable wrapped token for each token of the second number of tokens to provide a second number of recoverable wrapped tokens;
transferring, by the disperser contract, the second number of recoverable wrapped tokens to a recipient account associated with the recipient within the cryptocurrency network;
transferring at least a portion of the second number of recoverable wrapped tokens to a recovery pool; and
transferring a number of tokens from the recovery pool to the recipient account, the number of tokens being equal in value to the at least a portion of the second number of recoverable wrapped tokens.

8. The computer-implemented method of claim 7, wherein transferring at least a portion of the second number of recoverable wrapped tokens to a recovery pool and
transferring a number of tokens from the recovery pool to the recipient account are executed prior to expiration of a recovery period defined by the recovery wrapper contract.

9. A non-transitory computer-readable storage medium coupled to one or more processors and having instructions stored thereon which, when executed by the one or more processors, cause the one or more processors to perform operations comprising:
receiving, by a disperser contract executed within a cryptocurrency network, a first number of tokens of a digital asset associated with a payer;
providing, by a recoverable wrapper contract executed within the cryptocurrency network, a recoverable wrapped token for each token of the first number of tokens to provide a first number of recoverable wrapped tokens;
transferring, by a disperser contract executed within the cryptocurrency network, the first number of recoverable wrapped tokens to a recipient account associated with a recipient within the cryptocurrency network; and
prior to expiration of a recovery period:
executing a freeze function to freeze at least a portion of the first number of recoverable wrapped tokens, and
executing a recovery function to transfer the at least a portion of the first number of recoverable wrapped tokens to an account associated with the payer.

10. The non-transitory computer-readable storage medium of claim 9, wherein the freeze function is initiated by the recipient and is signed by the recipient using a private key associated with the recipient within the cryptocurrency network.

11. The non-transitory computer-readable storage medium of claim 9, wherein the recovery function is initiated by an arbiter and is signed by the arbiter using a private key associated with the arbiter within the cryptocurrency network.

12. The non-transitory computer-readable storage medium of claim 9, wherein the recovery function is executed by a returner contract executed within the cryptocurrency network.

13. The non-transitory computer-readable storage medium of claim 9, wherein operations further comprise determining that a disperse condition has occurred, wherein providing the first number of recoverable wrapped tokens and transferring the first number of recoverable wrapped tokens are performed in response to the disperse condition.

14. The non-transitory computer-readable storage medium of claim 13, wherein the disperse condition comprises one of:
a number of minutes since a last dispersal meets a threshold number of minutes; and
a number of recipient that have received payments since a last dispersal meets a threshold number of recipients.

15. The non-transitory computer-readable storage medium of claim 9, wherein operations further comprise:
receiving, by the disperser contract, a second number of tokens of a digital asset associated with a second payer;
providing, by the recoverable wrapper contract, a recoverable wrapped token for each token of the second number of tokens to provide a second number of recoverable wrapped tokens;
transferring, by the disperser contract, the second number of recoverable wrapped tokens to a recipient account associated with the recipient within the cryptocurrency network;
transferring at least a portion of the second number of recoverable wrapped tokens to a recovery pool; and
transferring a number of tokens from the recovery pool to the recipient account, the number of tokens being equal in value to the at least a portion of the second number of recoverable wrapped tokens.

16. A system, comprising:
one or more processors; and
a non-transitory computer-readable storage device and having instructions stored thereon which, when executed by the computing device, cause the computing device to perform operations comprising:
receiving, by a disperser contract executed within a cryptocurrency network, a first number of tokens of a digital asset associated with a payer;
providing, by a recoverable wrapper contract executed within the cryptocurrency network, a recoverable wrapped token for each token of the first number of tokens to provide a first number of recoverable wrapped tokens;
transferring, by a disperser contract executed within the cryptocurrency network, the first number of recoverable wrapped tokens to a recipient account associated with a recipient within the cryptocurrency network; and
prior to expiration of a recovery period:
executing a freeze function to freeze at least a portion of the first number of recoverable wrapped tokens, and
executing a recovery function to transfer the at least a portion of the first number of recoverable wrapped tokens to an account associated with the payer.

17. The system of claim 16, wherein the freeze function is initiated by the recipient and is signed by the recipient using a private key associated with the recipient within the cryptocurrency network.

18. The system of claim 16, wherein the recovery function is initiated by an arbiter and is signed by the arbiter using a private key associated with the arbiter within the cryptocurrency network.

19. The system of claim 16, wherein the recovery function is executed by a returner contract executed within the cryptocurrency network.

20. The system of claim 16, wherein operations further comprise determining that a disperse condition has occurred, wherein providing the first number of recoverable wrapped tokens and transferring the first number of recoverable wrapped tokens are performed in response to the disperse condition.
